(19) United States
(12) Patent Application Publication
(10) Pub. No.: US 2012/0160832 A1
(43) Pub. Date: Jun. 28, 2012

(54) GEAR PART AND METHOD OF PRODUCING THEREOF

(76) Inventor: Takemori TAKAYAMA, Hirakata-shi (JP)

(21) Appl. No.: 13/411,928

(22) Filed: Mar. 5, 2012

Related U.S. Application Data
(62) Division of application No. 10/984,833, filed on Nov. 10, 2004, now abandoned.

(30) Foreign Application Priority Data
Nov. 14, 2003 (JP) 2003-385597
Oct. 25, 2004 (JP) 2004-309297

(51) Int. Cl. H05B 6/10

(52) U.S. Cl. 219/640

(57) ABSTRACT

A gear part has a quench hardened layer around the teeth surface thereof. The gear part is made of a steel containing carbon of 0.43 to 1.2 wt %, and a relationship between a DI value and a module M (mm) of the gear part satisfies an expression of DI≦0.12×M+0.2. An alloy element concentrates in the cementite phase in a pretreated steel, thereby causing concentration of the alloy element in the ferrite phase in the pretreated steel to decrease, and a rapid induction heating to A3 transformation temperature or Acm transformation temperature causes carbon of 0.3 to 0.8 wt % to diffuse and dissolve in the austenite phase, and the DI value is determined by using a concentration of the alloy element and a concentration of the carbon. The alloy element is one or more elements selected from the group consisting of Mn, Cr, Mo, V and the like.

This application is a Divisional Application of Ser. No. 10/984,833 filed Nov. 10, 2004, which claims the benefit of patent application numbers 2003-385597, filed in Japan on Nov. 14, 2003 and 2004-309297, filed in Japan on Oct. 25, 2004, the subject matter of which is hereby incorporated herein by reference.

### FIELD OF THE INVENTION

The present invention relates to a gear part having a quench hardened layer around the teeth surface of the gear part formed by induction hardening (induction heating) and a producing method thereof. More particularly, the present invention relates to an induction hardened gear part excellent in pitting strength in which preventing the quench hardened layer from through-hardening allows compressive residual stress to remain at the pitch circle of the gear part and producing method thereof.

### BACKGROUND OF THE INVENTION

Generally, reducers for use in construction machinery applications and civil engineering machinery applications, in which high resistance of contact stress (200 kgf/mm² or more) is required, are equipped with gears made of low carbon steels such as SCr, SCM or SNCM to which carburization or carburization/carbonitriding is applied. However, since such carbonization or carburization/carbonitriding applied gears are expensive, gears made of carbon steel having a carbon of an amount of 0.35 to 0.5 wt % to which induction hardening is applied, as shown in table 1, (as described in Iron and Steel Institute of Japan, “Heat Treatment of Steel”, MARUZEN Co. Ltd, (1985.3.15), p 110, table 2.38, table 2.39), are sometimes used under such a condition that contact stress strength is comparatively low (less than 150 kgf/mm²). And, as shown in FIG. 13 (described in the aforesaid reference, P 258), various quench hardening methods for gears have been carried out, such as a method (a) for quenching all teeth at once, a method (b) for quenching teeth one by one, a method (c) for quenching teeth by moving a heating inductor from both sides of the teeth, a method (d) for quenching teeth by moving a heating inductor from one side of the teeth and a method (e) for quenching teeth by moving a heating inductor through teeth space.

Conventional technologies related to the present invention are disclosed in Japanese Patent Publication No. 2003-27181 and Japanese Patent No. 2769206. In, Kanjiro Takahashi et al, “Application of High Frequency—Induction Heating, Dielectric Heating, Supersonic Wave” Tokyo Denki University Press, 1979.5.20, p. 91, an exemplary method for quenching all teeth of a gear at once in order to form a quench hardened layer around the teeth surface of the gear is described.

Gears equipped in reducers applicable to construction machinery applications and civil engineering, machinery applications, from a viewpoint of high output power and compactness, require higher contact strength and higher mechanical strength as well as low cost manufacturing. Therefore, gears to which induction hardening is applied for forming a quench hardened layer around the teeth surface of the gear also require the same or more toughness as a carborized gear so as to improve contact strength relating to pitting, scuffing and wear of the teeth surface.

The aforesaid quench hardening method (a) for quenching all teeth of a gear at once is an excellent method in high productivity. In the method, as shown in a right-side column of FIG. 13(a), the teeth portions of the gear often through-harden so that compressive residual stress remains at the teeth roots and the dedendums, thereby resulting in enhancing teeth root strength and dedendum strength. However, since tensile residual stress occurs at the pitch circle, the method has a problem in that contact strength is not improved sufficiently.

For an example of a quench hardening method for quenching all teeth of a gear at once in order to form a quench hardened layer around the teeth surface of the gear, the following two methods have been known as disclosed in the second reference;

(1) a double induction hardening method in which the teeth tips and teeth flanks of the gear are quench hardened by induction heating at a higher frequency after the teeth roots thereof are induction heated at a lower frequency, and,
(2) a preheating hardening method in which a whole gear is first preheated at about 500° C. and second instantaneously heated to a hardening temperature by a large power, and then cooled rapidly.

However, these two such methods cause costly and structural problems in facilities because a suitable frequency varies significantly depending on a module M (corresponding to size) of the gear. In addition, in the case of a ring gear having an internal gear, of which an area to be heated becomes wide, only a gear having a through-hardened layer is obtained even if the aforesaid method (2) will be employed.

And, it is known that when gears are used under rolling conditions accompanied with sliding, heat is generated by local adhesion due to sliding under boundary lubrication. For example, when a carburized gear is used under such a condition that high contact stress is applied to the teeth surface of the gear, a temperature at the teeth surface rises to about 300° C. On the other hand, when an induction hardened gear is used under such a condition, since the quench hardened layer, in which a carbon steel or a low alloy steel having a carbon of an amount of 0.35 to 0.5 wt % is induction hardened, does not have sufficient tempering resistance, there will be a problem in that contact strength relating to pitting, scuffing and wear of the teeth surface is not sufficient.

### SUMMARY OF THE INVENTION

In order to solve the above-mentioned problem, an object of the present invention is to provide a gear part which will improve contact strength and a producing method thereof.

A gear part according to the present invention has a quench hardened layer around the teeth surface of the gear part, wherein the gear part is made of a steel containing carbon of an amount of 0.43 to 1.2 wt %, and a relationship between a DI value (inch) showing a hardenability of austenite phase at a pitch circle of the gear part and a module M (mm) of the gear part satisfies an expression of DI≦0.12×M+0.2

In the gear part according to the present invention, it is preferable that an alloy element concentrates in cementite phase in a pretreated steel, thereby causing concentration of the alloy element in ferrite phase in the pretreated steel to decrease, and a rapid induction heating to A3 transformation temperature or Acm transformation temperature or more causes carbon of an amount of 0.3 to 0.8 wt % to diffuse and dissolve in austenite phase, and the DI value is determined by using a concentration of the alloy element in the ferrite phase and a concentration of the carbon which diffuses and dissolves in the austenite phase.

And, it is preferable that the alloy element is one or more elements selected from the group consisting of Mn, Cr, Mo, V and the like.

In the gear part according to the present invention, it is possible that the steel contains Mn of an amount of 0.05 to 0.55 wt %, Cr of an amount of 0 to 0.6 wt %, one or more elements selected from the group consisting of Si, Al, Mo, V, Ni, Ti, Cu, W, B, Ca and Nb, one or more unavoidable impurity elements selected from the group consisting of P, S, N and O, and a residue made of Fe.

A producing method of a gear part according to the present invention comprises a step for preparing a original gear part made of steel containing carbon of an amount of 0.43 to 1.2 wt %, in which the relationship between a DI value (inch) showing a hardenability of austenite phase at a pitch circle of the gear part and a module M (mm) of the gear part satisfies an expression of DI≦0.12×M+0.2, and a step for forming a quench hardened layer around the teeth surface of the original gear part by induction hardening.

In the producing method for the gear part according to the present invention, it is preferable that an alloy element concentrates in cementite phase in a pretreated steel, thereby causing concentration of the alloy element in ferrite phase in the pretreated steel to decrease, and a rapid induction heating to A3 transformation temperature or Acm transformation temperature or more causes an amount of 0.3 to 0.8 wt % carbon to diffuse and dissolve in austenite phase, and a DI value is determined by using a concentration of the alloy element in the ferrite phase and a concentration of the carbon which diffuses and dissolves in the austenite phase.

And, it is preferable that the alloy element is one or more elements selected from the group consisting of Mn, Cr, Mo, V and the like.

In the producing method for the gear part according to the present invention, it is also possible that induction hardening is carried out by heating an original gear part from A1 transformation temperature or less up to a quenching temperature of 900 to 1100° C. by a high frequency within 10 seconds for austenitizing and then rapidly cooling.

And, in the producing method for the gear part according to the present invention, it is also possible that induction hardening, is carried out by first pre-heating an original gear part at 300° C. to A1 transformation temperature, second induction heating within 3 seconds by high power, and then rapid cooling.

Further, in the producing method for the gear part according to the present invention, after the step for forming a quench hardened layer, a step for maintaining compressive residual stress of 50 kgf/mm² or more to the teeth surface layer including teeth tips, teeth addendums, teeth surface at the pitch circle, dedendums and the teeth roots of the gear part by physically processing the gear part may be added.

As described above, the present invention will provide a gear part which has improved contact strength and a producing method thereof.

### BRIEF DESCRIPTION OF THE DRAWINGS

FIG. 1 is a phase diagram for a Fe—C-M system and showing a mechanism of dissolution of cementite into γ phase by using constant carbon activity lines.

FIG. 2 is a drawing showing a constant carbon activity line of a Fe—C—Cr system.

FIG. 3 is a phase diagram showing an effect of each of alloy elements on Fe containing Si of 3 wt %.

FIG. 4(a) to (e) are drawings showing hardening patterns (M=3.25) when water splay quenching after heating wholly is carried out.

FIG. 5 is a graph showing a relationship between the DI values of the hardening patterns as shown in FIG. 4 and depth of hardening.

FIG. 6 is a drawing showing specimens used in a roller pitting test, FIG. 6(a) is a drawing showing a small roller specimen and FIG. 6(b) is a drawing showing a large roller specimen.

FIG. 7(a) is a graph showing a relationship between a induction heating temperature and a hardening hardness, FIG. 7(b) is a graph showing a relationship between a induction heating temperature and a concentration of carbon in martensite and FIG. 7(c) is a graph showing a relationship between a induction heating temperature and a volume of θ phase.

FIG. 8 is a graph showing roller pitting strength obtained by a pre-test.

FIG. 9 is a graph showing a relationship between a measured tempering hardness and a calculated tempering hardness.

FIG. 10 is a graph showing a relationship between a ratio of DI values and a ratio of hardened depths.

FIG. 11 is a graph showing pitting strength of a gear part according to the present invention.

FIG. 12 is showing a specimen used for measurement of slipping resistance.

FIG. 13 is a drawing showing various quench hardening methods for a gear.

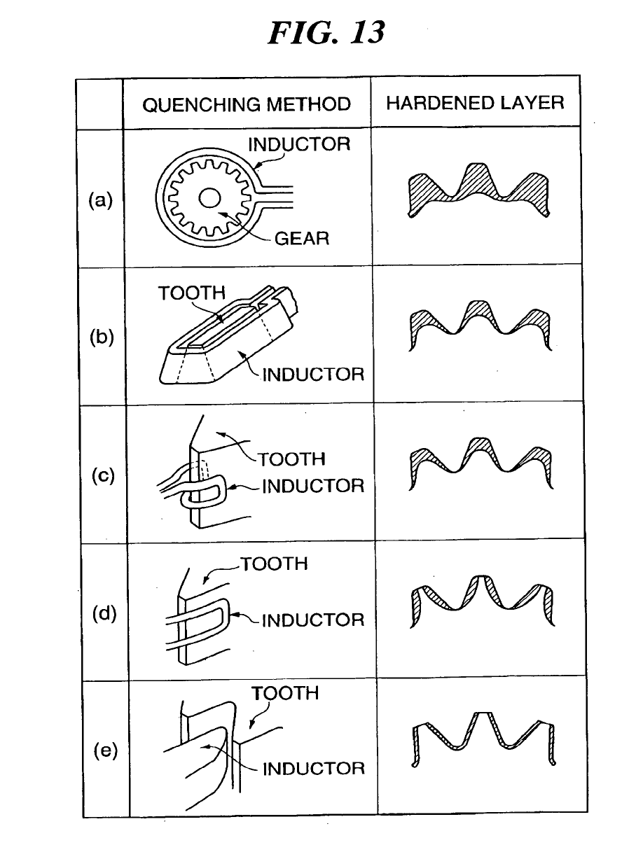

### DETAILED DESCRIPTION OF EMBODIMENTS OF THE INVENTION

A gear part according to the present invention has a quench hardened layer around the teeth surface of the gear part manufactured by a method for induction hardening all teeth of a gear at once. When an alloy element such as Mn, Cr, Mo, V, W and the like which improves a hardenability concentrates in a cementite phase in a pretreated steel, concentration of such an alloy element in a ferrite phase which coexists with the cementite phase decreases on the contrary. The pretreated steel is induction heated to Ac3 transformation temperature or more to form an austenite phase therein, and only carbon in the cementite phase substantially diffuses and dissolves in the austenite phase. As a result, a DI value indicating a substantial hardenability of the austenite phase can be maintained as low as 0.35 to 1.0 (inch). And, when a relationship between the DI value and a module M (mm) of the gear part will satisfy an expression of DI≦0.12×M+0.2, the quench hardened layer at a pitch circle of the gear part does not through-harden. This enables compressive residual stress remain at the pitch circle, whereby an induction hardened gear part excellent in pitting strength can be obtained. In addition, in order to increase pitting strength under rolling conditions accompanied with sliding of the gear, it is preferable that a steel containing Si and Al which may considerably improve low temperature tempering resistance at a low temperature of 140 to 350° C. is used. Hereby, an induction hardened gear part achieving contact strength higher than that of a gear formed by carburization can be provided.

Further, a gear part according to the present invention is made such that cementite and at least one of carbide, nitride or carbonitride of one or more kinds of V, Ti, Zr, Ta and Hf are dispersed in an induction quench hardened layer. This enables the prevention of the occurrence of a local adhesion at sliding under rolling conditions. In addition, by adding a suitable amount of Al and Ni to the steel, a gear part having high toughness can be achieved even under a high hardness condition.

The preferred embodiments of the present invention will be described in detail with reference to the accompanying drawings.

First, the following pre-test was carried out.

SNCM815 steel, SCM420 steel, SCr420 steel and SMnB420 steel, to which a carburization treatment is applied, respectively, (that is, carburizing case hardened steels), were pre-tested by a roller test under contact stress of 375 to 220 kgf/mm² for measurement of contact strength (roller pitting strength) under rolling conditions accompanied with sliding. As a result, contact stress was 210 kgf/mm², at which pitting begins to occur at a revolution of 10⁷ times. And, a half-bandwidth of X-ray of martensite phase in an outermost rolling surface layer, at which the pitting occurred under each contact stress, was lowered to 4 to 4.2°. In addition, considerable softening was observed at the outermost rolling surface layer.

On the other hand, S55C carbon steel, to which a quenching and tempering treatment was applied, was made to have a Rockwell Hardness of HRC61 to 62 and pre-tested by a roller test for measurement of rolling contact strength at contact stress of 250 kgf/mm². As a result, contact stress was about 180 kgf/mm², at which pitting begins to occur at a revolution of 10⁷ times. And, a half-bandwidth of X-ray of martensite phase in an outermost rolling surface layer, at which the pitting occurred under contact stress of 250 kgf/mm², was lowered to 3.6 to 4.2°, in the same manner as the carburizing case hardened steel.

And, a eutectoid carbon steel (carbon amount of 0.77 wt %) was pre-tested by the roller test for measurement of rolling contact strength. As a result, contact stress was about 230 to 240 kgf/mm², at which pitting begins to occur at a revolution of 10⁷ times, in the almost same manner as the carburizing case hardened steel having about the same carbon amount as that of the eutectoid carbon steel. However, in detail, since the carburizing case hardened steel varied in the rolling contact strength due to the existences of a grain boundary oxidation layer and an insufficiently quenched layer, the rolling contact strength thereof was lower than that of the eutectoid carbon steel.

And, another eutectoid carbon steel (carbon amount of 0.82 wt %) to which induction hardening was applied was pre-tested by the roller test for measurement of rolling contact strength. As a result, contact stress was about 260 to 270 kgf/mm², at which pitting begins to occur at a revolution of 10⁷ times. The contact stress was higher than that of the eutectoid carbon steel (carbon amount of 0.77 wt %). The reason why contact stress of the eutectoid carbon steel having a larger carbon amount is higher than that of the eutectoid carbon steel having a smaller carbon amount is that fine cementite particles were dispersed in martensite phase of the rolling surface.

With respect to dispersion of the fine cementite particles, a SUJ2 steel containing carbon of about 1.0 wt % and Cr of 1.5 wt %, quenched from 840° C. and then tempered so as to have a hardness of HRC62.5, was pre-tested by a roller test for measurement of rolling contact strength. As a result, contact stress was about 270 kgf/mm², at which pitting begins to occur at a revolution of 10⁷ times, in the same manner as that of the eutectoid carbon steel (carbon amount of 0.82 wt %). And, a half-bandwidth of X-ray of martensite phase of an outermost rolling surface layer, at which the pitting occurred under contact stress of 250 kgf/mm²′ was lowered to 4.2 to 4.5°, in the same manner as the carburizing case hardening steel.

And, a carbon steel each containing carbon of 0.46, 0.55, 0.66, 0.77 and 0.85 wt %, to which quench hardening was applied from 820° C. and then a tempering treatment was applied at 100 to 350° C. for 3 hours, was tested for measurement of a hardness and a half bandwidth of X-ray. Then, the measured data (a hardness and a half bandwidth of X-ray) was evaluated with reference to previously disclosed data (for example, shown in “Material”, Vol. 26, No. 280, p 26). As the results, a hardness in which a half bandwidth of X-ray of martensite phase is 4 to 4.2° was corresponding to a state in which a tempering was carried out until the hardness became HRC51 to 53. And, the state in which the hardness was HRC51 to 53 was in turn corresponding to a state in which tempering carried, out at about 300° C., when considering that the carburizing case hardened steel was made such that the surface carbon concentration was adjusted at 0.7 to 0.9 wt %.

The results of the pre-tests demonstrate that the outermost teeth surface of the gear was tempered and softened by heat generated when the gears were engaged with each other at high contact stress, whereby pitting occurred. Accordingly, it appears that an induction hardened gear requires a tempering hardness of HRC53 or more at 300° C. for a purpose to obtain pitting strength equal to that of the carburizing quenched gear.

In comparison between a tempering hardness at 300° C. of a carburized layer of a carburized SCM420 steel and a tempering hardness at 300° C. of a quench hardened eutectoid carbon steel, it was found that Cr and Mo hardly improves tempering resistance. Accordingly, in order for a gear formed by induction hardening to obtain pitting strength higher than that of a gear formed by carburizing, it is necessary to form a new alloy which improves tempering resistance at a low temperature of about 300° C. Moreover, in view of the good results of rolling contact strength of each of the eutectoid carbon steel (carbon amount of 0.82 wt %) and the SUJ2, it is apparent that rolling contact strength can be considerably improved by dispersing fine and hard cementite particles having a particle diameter of 0.1 to 1.5 μm throughout martensite phase.

And, the dispersion of the cementite particles, as mentioned above, can also improve seizure resistance for a local adhesion occurred at a rolling surface during sliding under boundary lubrication conditions as well as rolling contact strength. Accordingly, a temperature at an outermost rolling surface can be lowered and wear resistance of the surface can be improved (hard particle dispersion effect).

And, in order to manufacture an induction hardened gear withstanding pitting strength (contact stress Pmax of 230 kgf/mm² or more) equal to or higher than that of a carburized gear, based on a theoretical analysis about Hertz's contact stress, a hardness to withstand fatigue strength of shear stress (R=0) of 0.3 times contact stress is set and is about HRC53.4 obtained by calculation. The calculated hardness well agrees with the hardness (HRC=53) of the half bandwidth of X-ray of the martensite phase of the rolling surface at which pitting occurred, which was obtained by the pre-test. However, in the case of the hardness (HRC=53), since frictional heat was generated during rolling movement accompanied with sliding and thus the temperature of the outermost rolling surface rose to about 300° C. at which point pitting occurred, a tempering hardness at 300° C. is specified to be HRC53 or more withstanding at contact stress of at least Pmax=230 kgf/mm². Hereby, a gear having contact stress equal to or higher than that of a carburized gear can be achieved.

As described later in Example 2, each tempered martensite phase of which carbon steel having carbon of 0.1 to 1.0 wt % was tempered at 250° C., 300° C. and 350° C. has the following hardness, respectively:

HRC=34× square of carbon concentration (w %)+26.5 (at 250° C.);

HRC=36× square of carbon concentration (wt %)+20.9 (at 300° C.); and

HRC=38× square of carbon concentration (wt %)+15.3 (at 350° C.)

Based on these hardnesses, effects of various alloy elements on the hardness of the tempered martensite phase at 300° C. were examined. The results of the examinations demonstrate that the hardness of tempered martensite phase at 300° C. can be expressed in the following expression:

HRC=(36× square of carbon concentration (wt %)+20.9)+4.33×Si concentration (wt %)+7.3×Al concentration (wt %)+3.1×V concentration (wt %)+1.5×Mo concentration (wt %)+1.2×Cr concentration (wt %)×(0.45/carbon concentration (wt %)).

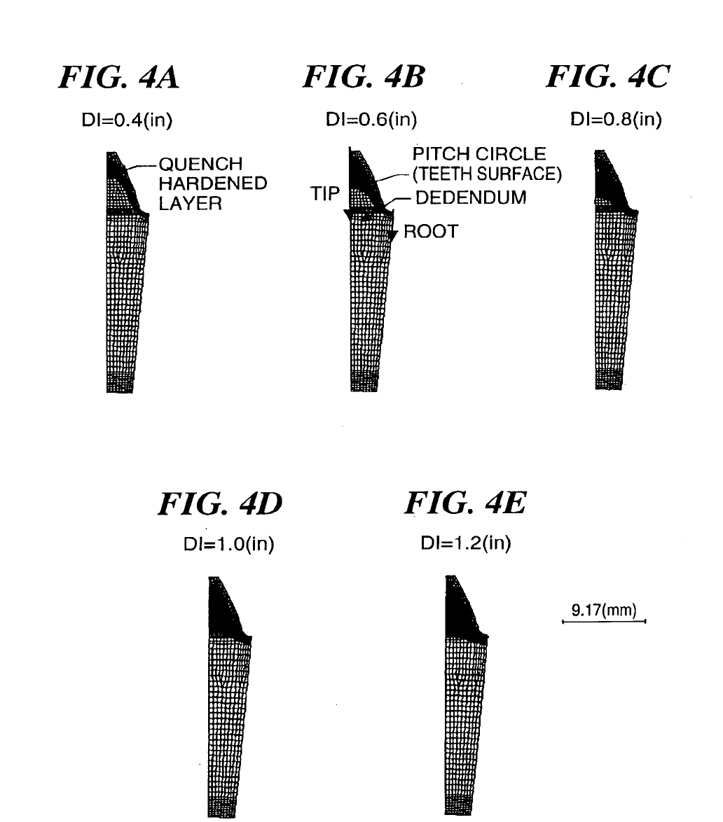

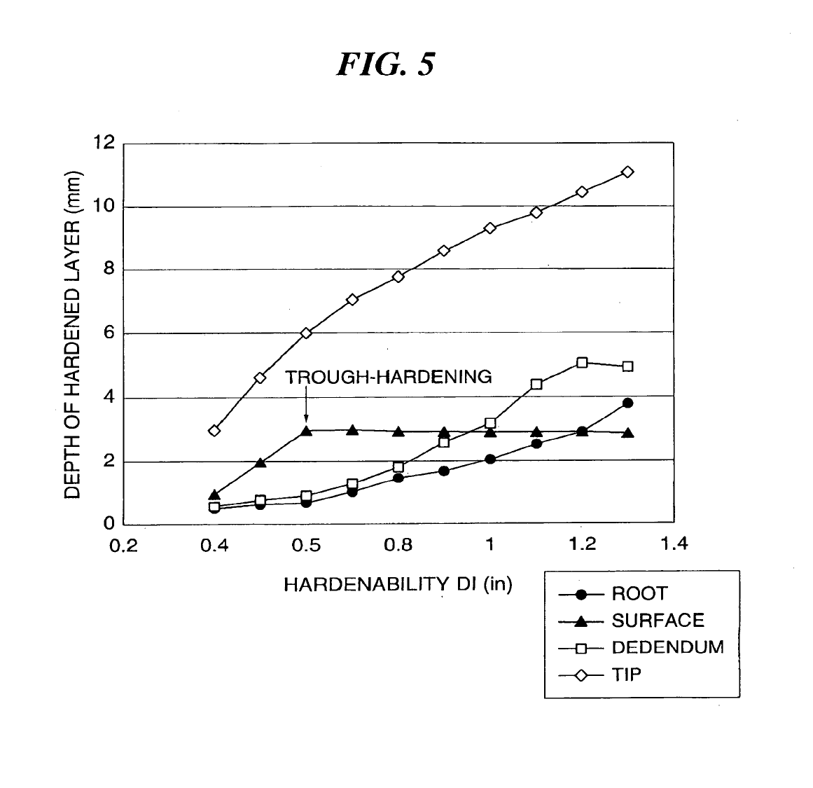

FIG. 4(a) to (e) are drawings showing hardening patterns (M=3.25) when water splay quenching after heating wholly is carried out. FIG. 5 is a graph showing a relationship between the DI values of the hardening patterns as shown in FIG. 4 and depth of hardening. In an embodiment of the present invention, on the condition that original gears having a module M of 2 to 15 (mm) were heated to 900° C. and then quenched by cooling power (4 inch⁻¹) equivalent to water splay quenching, a relationship between a depth of a quench hardened layer of the gear and a DI value (inch) of a steel was calculated. Further, a relationship between the depth of the quench hardened layer and residual stress at the teeth surface of the gear was also calculated. The result shows that the quench hardened layer at the pitch circle of the gear just through-hardened at which point tensile residual stress was generated. And, the through-hardening can be prevented under a condition satisfying the following expression of DI≦0.12×M+0.2. In addition, it was found that an original gear was induction heated from the teeth tip to a predetermined position along the teeth roots to Ac3 transformation temperature or more and then quenched by the induction hardening method (a) for quenching all teeth of the original gear at once, thereby forming a quench hardened layer around the teeth surface of the original gear. Further, from the relationship between the depth of the quench hardened layer and a hardenability of the steel (in other words, the DI value), as shown in FIG. 5, it was found that when the DI value, at which the quench hardened layer of the pitch circle through-hardened, becomes a minimum (as shown in arrows in the figure), the depth of the quench hardened layer of the dedendum can be adjusted to be one-third the module M (mm). This enables a gear having sufficient mechanical strength at its dedendum to provide.

And, from the expression of DI≦0.12×M+0.2, in the case of the most conventionally used gear having a module M of 2, DI≦0.44, and in the case of M=4, DI≦0.68. And, even applying induction hardening to a steel having a lowest DI value among carbon steels (described in the first reference) containing carbon of 0.4 wt % or more and Mn of 0.6 wt % or more did not prevent the quench hardened layer at the pitch circle from through-hardening. Also, applying induction hardening to a conventional carbon steel (DI=1.2) containing carbon of 0.5 wt % and Mn of 0.8 wt % did not prevent the gear having module M as large as 8 from through-hardening. Further, when induction hardening was applied to the conventional carbon steel with additions of Si of 0.5 wt % or more and Cr of 0.1 wt % or more in order to improve tempering resistance, the DI value increased to 1.36 and the through-hardening of the gear having module M of as large as 9.5 was not prevented.

In the present invention, based on the results the heat treatment process for the gears, amount (wt %) of each alloy element contained in the steel was determined as follows.

A gear part according to the present invention has a quench hardened layer around the teeth surface of the gear part and is made of a steel containing carbon of an amount of 0.43 to 1.2 wt %. And, an alloy element such as Mn, Cr, Mo, V and the like concentrates in the cementite phase in a pretreated steel, thereby causing concentration of the alloy element in the ferrite phase in the pretreated steel to decrease on the contrary. And, a rapid induction heating to the A3 transformation temperature or Acm transformation temperature or more causes carbon of an amount of 0.3 to 0.8 wt % to diffuse and dissolve into the austenite phase. And, a DI value is determined by using a concentration of the alloy element in the ferrite phase and a concentration of the carbon which diffuses and dissolves in the austenite phase, and a relationship between the DI value (inch) showing a hardenability of the austenite phase at the pitch circle of the gear part and a module M (mm) of the gear part satisfies a expression of DI≦0.12×M+0.2

Since the depth of the quench hardened layer of the dedendum under a boundary condition at which the through-hardening occurs is adjusted to be about one-third the module M, when considering the hardening patterns of a conventional carburized gear, it is possible that a quench hardened layer is formed around the dedendums such that the depth of the quench hardened layer is adjusted to one-tenth to one-third the module M. Accordingly, the present invention can provide a gear part excellent in bending strength of the dedendums thereof.

The reason why the lower limit of the amount of carbon dissolved in the martensite phase of the quench hardened layer is set to 0.3 wt % is such that the quenched martensite phase may have a hardness of HRC55 or more, and the lower limit thereof is preferably 0.53 wt %. On the other hand, the upper limit of the amount of carbon is set to 0.8 wt % which is determined based on the amount of carbon in martensite phase of a carburized gear, and the upper limit of the amount of carbon is preferably 0.7 wt % in view of quenching crack during heat treatment. And, the larger an amount of coexistent cementite is in a pretreated steel, the larger the amount of an alloy element such as Mn, Cr, Mo, V, W and the like concentrates in the cementite phase, thereby causing concentration of the alloy element in the ferrite phase to decrease on the contrary. Accordingly, the DI value showing a substantial hardenability of austenite at induction hardening can be more lowered. From the relationship of DI≦0.12×M+0.2, in a producing method of a gear part having a quench hardened layer around the teeth surface thereof, it is preferable that a large amount of cementite coexists in a pretreated steel. Assuming that spheroidized cementite having an average diameter of 0.1 to 1.5 μm, which has little effect on bending fatigue strength of the gear, can be contained as large as an amount of 5% by volume (carbon amount is 0.3 wt %), the upper limit of an amount of carbon in a steel is set to 1.2 wt %, and more preferably 1.0 wt % in order to prevent lowering bending fatigue strength due to the dispersion of the spheroidized cementite.

And, when a pretreated steel in which ferrite phase coexists with cementite phase is equilibrium heated at 700° C., a distribution coefficient αKM of an alloy element M is shown by dividing a concentration (wt %) of the alloy element M in the cementite phase by a concentration (wt %) of the alloy element M in the ferrite phase. For example, a distribution coefficient αKCr of Cr is 28, the distribution coefficient αKMn of Mn is 10.5, the distribution coefficient αKV of V is 9.0, the distribution coefficient αKMo of Mo is 7.5, the distribution coefficient αKW of W is 2, the distribution coefficient αKNi of Ni is 0.34, the distribution coefficient αKSi of Si is 0 and the distribution coefficient αKAl of Al is 0. When Mn and Cr which significantly improve a hardenability of steel concentrates in cementite, concentrations of the alloy elements in the ferrite phase decrease on the contrary. In austenite during heating at induction hardening, although carbon in cementite rapidly diffuses and dissolves in austenite, the alloy elements concentrated in the cementite hardly diffuses. As a results, a DI value showing a substantially hardenability of a non-equilibrium austenite is considerably lowered.

Accordingly, in the gear part according to the present invention, it is preferable that a steel containing Mn of as small as an amount of 0.05 to 0.55 wt %, Cr of as small as an amount of 0 to 0.6 wt % at the maximum, one or more elements selected from the group consisting of Si, Al, Mo, V, Ni, Ti, Cu, W, B, Ca and Nb, one or more unavoidable impurity elements selected from the group consisting of P, S, N, O and the like, and a residue made of Fe is used. Mn is not concentrated in the cementite phase as compared to Cr and works to raise a DI value most. Accordingly, by maintaining an addition amount of Mn as small as 0.05 to 0.55 wt %, Mn concentrates in the cementite phase, thereby causing concentration of Mn in the ferrite phase in a pretreated steel to decrease on the contrary, thus a hardenability can be controlled.

Further, when a suitable amount of an alloy element such as Cr and Mo, concentrated in cementite significantly, is added to a pretreated steel, concentrations of Cr and Mo in the ferrite phase are maintained as low as possible, thereby preventing a DI value showing a substantial hardenability from becoming too high. Preferably, Cr of an amount of 0 to 0.25 wt % and Mo of an amount of 0 to 0.2 wt % are contained in the ferrite phase from an economical viewpoint. And, Cr of an amount of 0 to 0.6 wt %, and both or either one of Mo and W of an amount of 0 to 0.3 wt %, respectively, are preferably contained in a pretreated steel.

When Cr concentrates in the cementite phase in a pretreated steel too much, induction hardening at 850 to 1100° C. for a short period causes the cementite to remain without dissolving for the heating period. However, as a result, there is a problem in which the concentration of carbon in the martensite phase formed by induction hardening becomes too low. Consequentially, according to another embodiment of the present invention, by maintaining an average concentration of Cr in the cementite phase diffused in a pretreated steel as low as an amount of 3.5 wt % or less, the concentration of carbon in the austenite phase during induction hardening can be maintained to 0.3 wt % or less.

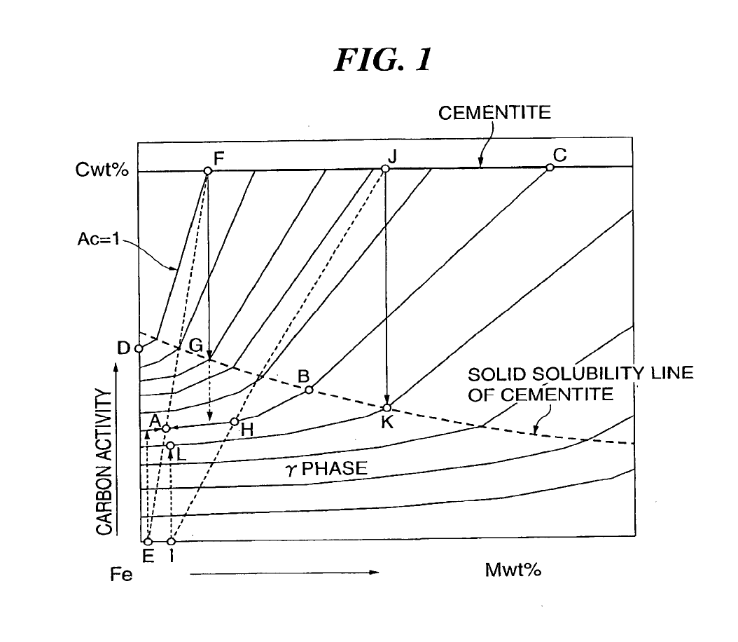

A mechanism (velocity) in which the cementite phase in which Cr concentrates dissolves in austenite during induction hardening can be explained by using a Fe—C-M (alloy element) three system phase diagram at the heating temperature as shown in FIG. 1 and a constant carbon activity line as shown in FIG. 1.

FIG. 1 is a phase diagram for a Fe—C-M system in which an alloy element M has the almost the same affinity with carbon as that of Cr. In the figure, constant carbon activity lines are represented by thin lines. A constant carbon activity line of a carbon activity of a steel having a composition shown as a point A in the figure transfers as shown in a thin line (a constant carbon activity line) passing through the point A in the figure. For details, the constant carbon activity unproportionally increases as the amount of the alloy element M increases, because increasing of carbon activity is suppressed as the amount of the alloy element M increases. The constant carbon activity line is followed by crossing with a line showing a degree of solid solubility of cementite at a point B in the figure, and then connected at a point C in the figure showing a composition of cementite containing the alloy element M at equilibrium with the point B.

Another constant carbon activity lines (as represented in thin lines in FIG. 1) are determined according to each carbon activity. The carbon activity becomes higher as the concentration of carbon increases. Here, the carbon activity Ac is defined as 1 at a point D in the figure showing a solid solubility of graphite along a Fe—C axis (in a Fe—C two-system).

As for the steel having the composition shown at the point A in the FIG. 1, compositions of ferrite and cementite of the steel before quenching are shown in a point E and a point F in the figure, respectively. On rapid heating to a quenching heating temperature, in the cementite having a composition shown at the point F heated at such the temperature, the alloy element M does not dissolve but only carbon having a significantly high diffusion ability dissolves in austenite rapidly. In such a case, a carbon activity shown at a point G in the figure showing a composition of an austenite boundary at local equilibrium with a cementite boundary is larger than the carbon activity of the steel shown at the point A. From this result, carbon diffuses in the steel rapidly due to a gradient of chemical potential of carbon. And, at regions where cementite dissolves and is being originally ferrite, carbon is first homogenirized along the constant activity line in FIG. 1, as shown in arrows of FIG. 1, and then the alloy element is second homogenirized.

However, when a large amount of the alloy element M is added in the steel (a point H in the figure) and a large amount of the alloy element M concentrates in the cementite (a point J in the figure), a carbon activity (a point K in the figure) of austenite equilibrium to the cementite, in which the alloy element M does not dissolve but only carbon dissolves, becomes lower than the carbon activity at the point H. As the results, it is found that while carbon rapidly diffuses to a concentration as shown in a point L in the figure along the constant carbon activity line passing through a point K in the figure for a very short period, the dissolving proceeds such that the cementite can not dissolve without diffusion of the alloy element M along the solid solubility line of cementite from the point K to the point B during the cementite completely dissolves. And, the dissolving of the cementite is suddenly suppressed by a rate-controlling of the diffusion of the alloy element M.

And, a period in which the cementite completely dissolves becomes longer as the concentration of the alloy element M in the cementite increases larger than the concentration of the alloy element M at the point B at which the constant carbon activity line passing through the point A and the point H is crossed with the solid solubility line of the cementite. In order to decrease the amount of the cementite which does not dissolve at the induction heating and quenching, it is necessary that the concentration of the alloy element M in the cementite is adjusted to the concentration or less of the alloy element M at the point B. In addition, since the concentration of carbon at the point L along the constant carbon activity line passing through the point K almost corresponds to the concentration of the carbon in the martensite parent phase in which cementite does not dissolve but diffuses, it is found that the concentration of carbon at the point L may be set to 0.3 to 0.9 wt % according to the present invention. And, it is necessary that a J point in the figure at which the concentration of carbon at the L point is 0.3 to 0.9 wt % is controlled.

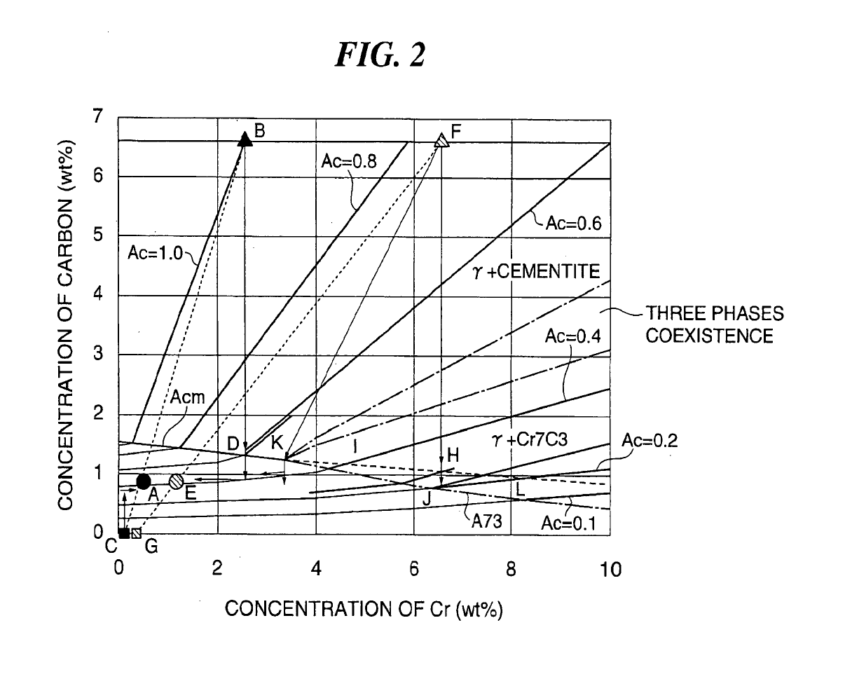

Specifically, induction hardening in which a quenching treatment is carried out by rapidly heating at 1000° C. will be studied based on a Fe—C—Cr three system phase diagram as shown in FIG. 2 and the constant carbon activity lines (at 1000° C.)

(1) A case in which cementite dissolves rapidly (a case in which the concentration of Cr in the cementite is low)

When a steel shown as the point A of FIG. 2 (which has carbon of 0.8 wt % and Cr of 0.4 wt %) is sufficiently heated at 700° C. at which cementite coexists with ferrite, the steel is changed to have a composition including cementite containing Cr of 2.6 wt %, shown at the point B, and ferrite containing Cr of 0.09 wt %, shown at the point C. Then, when the steel having the changed composition is rapidly heated at 1000° C. to be austenitized, the point B and the point C transfer toward the point A along the arrows in the figure, causing the ferrite and the cementite to be homogenized. However, carbon rapidly diffuses, as shown in arrows of the figure, in the austenite (the point being originally ferrite structure via the point D in the figure, while the alloy element M contained in the cementite at the point B hardly diffuses in the austenite. After the cementite dissolved, Cr is gently homogenized toward the point A along the constant carbon activity line passing through the point A with diffusion of Cr. And, at a point in which the cementite dissolves completely by the rapidly induction heating, the concentration of carbon in the martensite parent phase becomes equal to the concentration of carbon at the point A. This enables martensite having a higher hardness to be proved.

Accordingly, in the present invention, the concentration of Cr in the cementite is set to 3.5 wt % when the concentration of carbon dissolved in the martensite phase becomes 0.9 wt %. Consequentially, it is found that controlling the concentration of Cr in the cementite to 3.5 wt % or less prevents remaining of undissolved cementite.

(2) A case 1 in which the dissolution of the cementite is greatly delayed.

When a steel shown as the point E of FIG. 2 (which has carbon of 0.8 wt % and Cr of 1 wt %) is sufficiently heated at 700° C. at which cementite coexists with ferrite, the steel is changed to have a composition including ferrite containing Cr of 0.24 wt %, shown at the point G, and cementite containing Cr of 6.61 wt %, shown at the point F. Then, when the steel having the changed composition is rapidly heated at 1000° C. to be austenitized, the point F transfers toward the point H, causing the ferrite and the cementite to be homogenized. Since the carbon activity at the point H (an austenite boundary having a carbon activity equal to that of the cementite when the cementite dissolves) becomes lower than that at the point E, the cementite first dissolves by the carbon diffusion rate controlling mechanism until the constant carbon activity line passing through the point H. And then, the point H showing a composition of γ phase at equilibrium with the cementite transfers along the solid solubility line of the cementite toward the point I, having the same carbon activity as the point E, on the solid solubility line of the cementite. This results that the cementite dissolves with diffusion of Cr, and then the cementite completely dissolves when a composition of the γ phase has a composition at the point I. And, the concentration of carbon in the martensite parent phase after quenching is about 0.6 wt %. It is found that the cementite of about 3% by volume does not dissolve but diffuses in the very hard martensite phase. And, it is understood that the upper limit of the concentration of Cr in the cementite phase is about 10 wt % when the concentration of carbon in the martensite parent phase is 0.35 wt %. Accordingly, controlling the concentration of Cr in the cementite phase to set to 3.5 to 10 wt % makes it possible to obtain a quench hardened layer in which undissolved cementite disperses in the martensite parent phase having carbon of 0.35 to 0.9 wt %.

(3) A case 2 in which the dissolution of cementite is greatly delayed.

The point H in the case of (2) assumed such that a two-phase equilibrium in which Cr₇C₃ carbide different from the cementite is equilibrium to the γ phase and the cementite is not equilibrium to the γ phase is formed during the dissolving process of the cementite. In such a dissolving process of the cementite, the cementite dissolves by the carbon diffusion rate controlling until the constant carbon activity line (about 0.2) passing through the point J on the solid solubility line of the Cr₇C₃ carbide. In the subsequently process of the dissolving of the cementite, a restriction condition is added, in which the point J, at which the Cr₇C₃ carbide does not precipitate before disappearance of the cementite, transfers along the solid solubility line of the Cr₇C₃ carbide toward the point K, in a three-phase (the γ phase and the cementite phase and Cr₇C₃ phase) coexistence region in which the Cr₇C₃ carbide does not need to precipitate. The restriction condition causes the dissolving of the cementite to more delay. In such a case, the concentration of carbon in the martensite parent phase obtained by the induction heating and quenching is about 0.45 wt %, and cementite of about 5% by volume does not dissolve but diffuses in the martensite parent phase having a hardness of HRC 57 to 61.

From the studied results, a significant delay in dissolving of cementite occurs when concentration of Cr in the cementite phase becomes about 3.5 wt % or more at the minimum under heating condition of 1000° C. When under a heating condition of 900° C., the concentration of Cr in the cementite phase is about 2.5 wt %. For example, when a steel containing carbon of 0.9 wt % and Cr of 0.6 wt % is heated at 700° C., the concentration of Cr in the cementite phase is 3.6 wt % obtained by using the following expression.

The concentration of Cr=αKCr× the concentration of Cr in the steel/(1−(the concentration of C in the steel/6.67)×(1-αKCr)).

As a result, the upper limit of the addition amount of Cr is about 0.6 wt %, and more preferably about 0.5 wt % or less. Here, αKCr shows a distribution coefficient showing the degree of concentrating of Cr between the ferrite phase and the cementite phase. The distribution coefficients αKCr of Cr, αKMn of Mn and αKMo of Mo at 600° C. are 52, 19, 12, respectively. It has been known that the higher the distribution coefficient of an alloy element is, the higher the tendency in which the alloy element concentrate in the cementite is.

When the concentration of Cr in the cementite phase is adjusted to 3.5 wt % or less, in the case that rapid induction heating is carried out, the dissolution of cementite is delayed by mobility of a boundary between cementite phase and austenite phase, in addition to the mechanism in which cementite is dissolved depending to the carbon diffusion rate controlling. As a result, the undissolved cementite disperses in the quench hardened layer. On the other hand, it is known that, in a bearing material made of SUJ2 in which cementite of 5% by volume or less is dispersed, the cementite particles do not exert bad influence on bending strength of the bearing material. Accordingly, in the present invention, it is possible that cementite of 5% by volume or less may be dispersed in the quench hardened layer.

And, Mn is an element which has the distribution coefficient αKMn higher than the distribution coefficients αKV and αKMo of V and Mo, respectively, and is easy to concentrate in cementite phase. In the composition range (Mn of an amount of 0.55 wt % or less and carbon of 0.43 wt % or more) of the present invention, since Mn of 4 wt % is contained in the cementite phase and Mn has behavior to decrease carbon activity less than half of the behavior of Cr, behavior to delay the dissolution of the cementite phase is hardly exhibited. Accordingly, when applied to a steel for a gear, in order to adjust a hardenability, a steel containing Mn of an amount of 0.55 wt % or less is preferably used. And, at the same time, a concentration of Mn in the ferrite phase is preferably set as small as an amount of 0.35 wt % or less.

And, when the amount of V will exceed 0.3 wt %, V₄C₃ carbide will remain in martensite parent phase after induction hardening and the V₄C₃ will enhance an afore-described hard particles dispersing effect (until 0.4% by volume). Thus V of an amount of 0.1 to 0.5 wt % should be preferably added.

The distribution coefficient αKM of an alloy element M between cementite phase and ferrite phase is determined when sufficiently heated at 700° C. So, when heated at 600° C., the distribution coefficient each of Cr, Mn, V and Mo becomes higher. However, if a heating period is too short, since such an alloy element does not sufficiently concentrate, it is preferable that a pre-heat treatment is carried out at a eutectoid temperature or less of the steel.

A pretreated steel may have any structure of pearlite, mixture of pearlite and ferrite, sorbite or spheroidized structure. However, it is undesirable for mechanical strength that plate-shaped cementite or ferrite having a pearlite structure respectively disperse in martensite parent phase of a quench hardened layer. In such a case, it is preferable that cementite for a pretreated steel is finely granulated so as to have an average particle diameter of 0.1 to 1.5 μm. The granulation of the cementite particles requires an addition of an element having a large distribution coefficient αKM, and the most preferable element is Cr, which most easily concentrates in cementite, of an amount of 0.05 to 1 wt %.

In such a case that a pretreated steel has a spheroidized cementite structure, when the spheroidization will be carried out by a thermal refining (quenching and tempering heat-treatment), it is necessary to use a steel having a high hardenability in order to form a deep martensite layer once. In the present invention, the spheroidization of cementite is preferably carried out by a spheroidizing annealing. Specially, using a steel added with a large amount of Si and Al, making a eutectoid temperature sufficiently higher, will result in that the heat treatment period becomes remarkably shorter.

Since the gear part is induction hardened in such a way that an alloy element such as Cr, Mo, V, Mn and the like concentrates in the cementite phase, homogenization of the alloy elements in the martensite parent phase of the quench hardened layer hardly proceeds, thereby causing tempering resistance to decrease. As a result, contact strength is not improved as compared to that of the carburizing quenched gear (a carburized surface concentration of carbon is 0.65 to 0.9 wt %). Accordingly, in the present invention, one or both of Si and Al, which hardly concentrates in the cementite phase but remains in the martensite parent phase efficiently thereby to increase tempering resistance of the martensite parent phase, are contained in a steel. Specifically, in the present invention, a steel, used for a gear part, contains either one of Si of 0.5 to 2 wt % or Al of 0.25 to 1 wt %, mixture of Si and Al of 0.5 to 2 wt %, and Cr of 0.05 to 0.6 wt %, one or more alloy elements selected from the group consisting of Mn, Ni, Mo, Cu, W, B, Ca and Nb, an unavoidable impurity element such as P, S, N, O and the like, and the residue made of Fe.

A carburization quenched gear part has a tempering parameter of about 2 determined by considering tempering resistance of an alloy element comparable to SCM420, of which the tempering parameter is calculated by using a following expression:

2≦4.3×Si (wt %)+7.3×Al (wt %)+3.1×V (wt %)+1.5×Mo (wt %)+1.2×Cr (wt %)×(0.45/C(wt %))

From the aforesaid expression, in the present invention, the lower limit of addition amount of Si is set to 0.5 wt %. And, the upper limit thereof is set to at 3 wt %, through as much as up to 2 wt % is effective in view of machinability.

On the other hand, since Al has tempering resistance higher than that of Si, the suitable lower limit of addition amount of Al is set to 0.25 wt %. Furthermore, since Al is a ferrite stabilized element and makes Ac3 transformation temperature to move about two times as higher as Si, the upper limit thereof is set to 1 wt %.

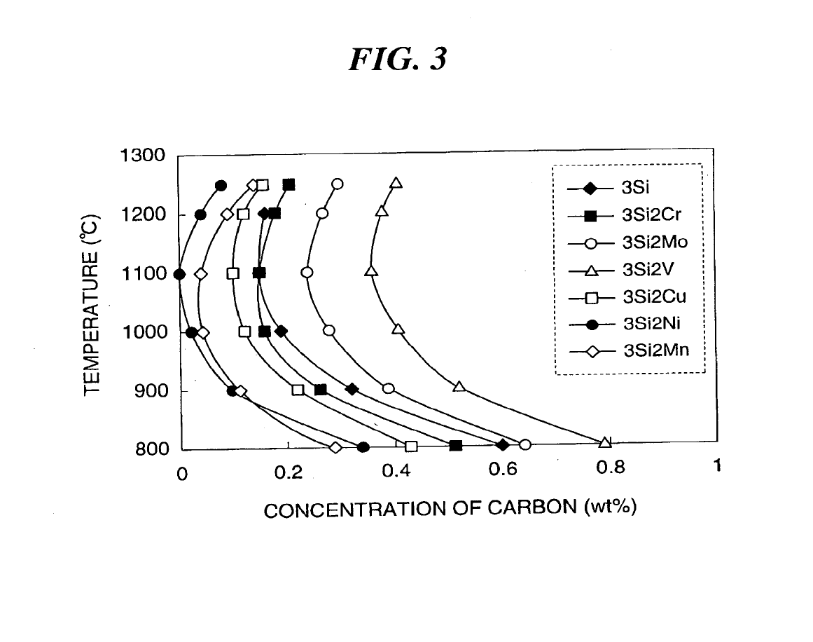

In the present invention, since a large amount of ferrite stabilized element, such as Si or Al, is added, it becomes a problem that the ferrite phase could remain in the quench hardened layer at induction hardening. Hereinafter, the problem will be studied. As shown in FIG. 3, when carbon of 0.35 wt % or more, preferably 0.45 wt % or more, is added to a steel to which Si of 3 wt % is added, the steel is sufficiently austenitized at a conventional heating temperature (850 to 1000° C.) of induction hardening. And, when Al, substitute for Si, is added, since Al has a ferrite stabilization ability two times of Si, the upper limit of addition amount of Al is preferably set to 1 wt % in the present invention.

On the other hand, when a large amount of Si or Ni enhancing tempering resistance is added, graphite easily precipitates during a steel fabrication process and a heating treatment. Therefore, in order to prevent the precipitation of graphite, a cementite stabilized alloy element, such as Cr, Mo, V and the like, of an amount of 0.05 wt % or more is preferably added.

A pretreated steel may have a structure of a mixture of ferrite and pearlite. However, in the case of the presence of rough ferrite, since homogenization is unlikely to occur by induction heating for a short period, in the present invention, it is preferable that carbide and carbonitride of Ti, V, Zr, Nb, Ta and Hf are contained and the structure of mixture of ferrite and pearlite is granulated finely, thereby to prevent occurrence of rough ferrite. And, it is also preferable that the concentration of carbon in the steel is adjusted to 0.6 wt % or more.

Since a steel used for a gear part requires a suitable hardenability withstanding a thermal refining treatment, it is preferable that Mo and W of an amount of 0 to 0.3 wt %, respectively, are contained. And, since an amount of Mn has been maintained as low as 0.05 to 0.55 wt %, an amount of S contained in the steel is preferably maintained, for example, as low as 0.015 wt % or less in order to provide an adequate desulfurization effect by MnS. In addition, in view of low thermal toughness, it is preferable that both or either one of Mo and W of an amount of 0.05 to 0.3 wt % is added. In the present invention, it is also possible that a steel containing Mo of 0.05 to 0.3 wt %, W of 0.05 to 0.3 wt %, one or more elements selected from the group consisting of Mn, Ni, Cu, B and Ca, an avoidable impurity such as P, S, N, O and the like, and the residue made of Fe is used.

Here, the reason why the upper limit of addition amount of Mo is set to 0.3 wt % is that if the addition amount of Mo exceeds the upper limit, undissoltion of cementite will occur by the same mechanism as the aforesaid mechanism ((3) A case in which the dissolution of the cementite is greatly delayed), whereby an effect to strengthen the martensite parent phase is hardly expected. On the other hand, the lower limit of the addition amount of Mo is determined based on the conventional amount of Mo withstanding temper brittleness. In view of toughness, it is preferable that an impurity element, such as P and O, of an amount of 0.015 wt % or less, more preferably 0.0015 wt % or less, is contained. In addition, it is also preferable that, complex deoxidation of Al and Ti is adequately carried out.

In order to improve toughness further, it is preferable that Ni of 0.3 to 1.5 wt % is added to a steel containing Al of 0.25 wt % or more. It is also preferable that a gear part is made of the steel.

And, the steel contains one or more alloy elements, selected from the group consisting of V, Ti, Zr, Nb, Ta and Hf, of an amount of 0.05 to 0.2 wt %, and one or more carbide, nitride and carbonitride having an average diameter of 0.1 to 5 μm and an amount of 0.1 to 0.5% by volume, made of the alloy element mainly, are dispersed in the steel. It is possible that the quench hardened layer has a rolling surface layer which contains carbon of 0.53 to 0.9 wt %, and the rolling surface is quenched and then tempered at a low temperature to form a parent phase having martensite structure. And, a gear part having such martensite parent phase can be formed.

In the martensite parent phase of the quench hardened layer of the induction hardened gear part, regions, being originally cementite before induction hardening and having high concentration of an alloy element such as Mn, Cr, Mo and the like, are dispersed into regions, being originally ferrite before induction hardening and having low concentration of such alloy element. For example, it is known by calculation that in the martensite phase of a steel containing Fe, carbon of 0.8 wt %, Mn of 0.4 wt % and Cr of 0.4 wt % to which induction hardening is applied after pre-treatment at 700° C., regions, being originally cementite before induction hardening and having a composition of Fe, C of 1.1 wt %, Mn of 2.3 wt % and Cr of 3.4 wt %, are dispersed into regions, being originally ferrite before induction hardening and having a composition of Fe, C of 0.75 wt %, Mn of 0.22 wt %, and Ms of 0.12 wt %. And, according to the Murai's relational expression; Ms (K)=667-195×C (wt %)−44.9×Mn (wt %)−19.6×Ni (wt %)−21.4×Cr (wt %)−20.7×Mo (wt %) (“Ferrum and Steel”, 84 (1984), p 446), Ms temperature of each of the regions is calculated to 3° C. and 233° C., respectively. From the result, it is found that a retained austenite phase formed in the region being originally cementite before induction hardening is very stable so that a quench hardened layer excellent in toughness can be formed by containing the retained austenite therein.

In the present invention, it is preferable that the stable retained austenite of at least 5 to 15% by volume or the stable retained austenite and another retained austenite (unstable austenite) of 10 to 40% by volume are contained, in which the unstable retained austenite derivaritively remains due to presences of stable retained austenite and un-dissolved cementite, or the unstable retained austenite is formed at the region being originally ferrite before induction hardening.

The unstable retained austenite hardly contributes to the improvement of toughness when impact is applied on the gear part, while it contributes to the improvement of conformability with martensitizing at the engagement the teeth of the gears parts with each other. On the other hand, the stable retained austenite contributes to improve the toughness and to strengthen the teeth surface when contamination is engaged between the teeth. In addition, if the retained austenite will be slightly abraded due to its softness during engaging the teeth with sliding under boundary lubrication, an oil pocket which works effectively to provide teeth surface lubrication is formed, exhibiting an efficient lubrication

As a method for the similar effect to provide teeth surface lubrication, Japanese Patent No. 2769206 discloses a method in which a lot of minute dents each having a depth of 0.5 to 2 μm are formed on the sliding surface in 10 to 40% by area. However, according to the method, when a lot of minute dents are formed on the teeth surface of a gear, since the depth of the dent is very shallow, such dents are abraded at an initial operating condition. As a result, a lubrication effect does not last for a long period. On the contrary, the present invention makes it possible that the lubrication effect lasts almost semipermanetary.

In order to improve contact fatigue strength and bending fatigue strength of the dedendum, it is preferable that at least one of treatments as described below is carried out, the treatment including dispersion of the stable retained austenite, a dispersion of un-dissolved cementite of an amount of 5% or less by volume, a dispersion of special carbide of an element such as V, Ti, Nb and the like, and a fining of martensite phase by fining austenite crystal grain into ATSM grain size number of 10 or more by a rapid induction hardening treatment. Such treatments make preventing propagation of cracks at fatigue breakdown.

For an induction hardening method, it is preferable that a steel used for a gear part is heated by a high frequency of 60 kHz or less from A1 transformation temperature or less to a quenching temperature of 900 to 1100° C. within for 10 seconds to be austenitized and then rapidly cooled. This enables the prevention of the crystal grain from coarsening. In the case that special carbide of an element such as V, Ti, Nb and the like is pre-dispersed in the steel used for gear part, it is preferable that the upper limit of heating temperature at the high frequency heating is set to 1050° C. And, it is preferable that a pretreated steel does not have structures of bainite and martensite in order to prevent coarsening of the crystal grain.

In order to prevent coarsening of the crystal grain and as well as to form a quench hardened layer around the teeth surface of the gear part by another induction hardening method, it is possible that a steel used for a gear part is pre-heated at 300° C. to A1 transformation temperature, then heated by a high frequency and a high power within 3 seconds, and rapidly cooled. This method leads to obtain a gear part having a quench hardened layer around the teeth surface of the gear part. Here, the pre-heating treatment is carried out in order to prevent occurrences of quenching strain and quenching crack of the gear part. In order to prevent the occurrence of the quenching crack and as well as to form a deep quench hardened layer at the teeth root, it is preferable that a period between the rapidly heating and the rapidly cooling is adjusted such that an area to be heated is heated and cooled uniformly before rapid cooling. In such a case, it is preferable that the rapid cooling starts when the surface temperature reaches at least 800° C.

When a gear part is used accompanied with sliding, it is preferable that the gear part has compressive residual stress remains at the teeth surface of the pitch circle, and compressive residual stress of 50 kgf/mm² or more remains at the teeth surface of the dedendums. This enables the improvement of bending fatigue strength of the dedendum and pitting strength. In order to remain compressive residual strength of 50 kgf/mm² or more at the teeth surface layer including the teeth tips, teeth addendums, teeth surface at the pitch circle, dedendums and the teeth roots, it is preferable that a physical processing treatment such as a shot peening process is carried out. The shot peening process causes compressive residual strength of 50 kgf/mm² or more to remain at the edge of the teeth surface, resulting in preventing occurrence of spalling fracture grew from a quenching boundary of the edge of the teeth surface.

In the present invention, even if a gear part cannot be outline-heated, a quench hardened layer can be formed so as not to through-harden at the teeth surface at the pitch circle of the gear part. Accordingly, the gear part may include an internal gear portion.

In a producing method of a gear part according to the present invention, a steel containing carbon of 0.43 to 1.2 wt % is used, in which an alloy element such as Mn, Cr, Mo, V and the like concentrates in cementite phase in a pretreated steel, thereby causing concentration of the alloy element in the ferrite phase in the pretreated steel to decrease on the contrary, and carbon of an amount of 0.3 to 0.8 wt % diffuses and dissolves in austenite phase by a rapid induction heating to A3 transformation temperature or Acm transformation temperature or more. A DI value (inch) is determined based on a concentration of the alloy element in the ferrite phase and a concentration of the carbon diffused and dissolved in the austenite phase, and having a relationship between the DI value showing a hardenability of the austenite phase at a pitch circle of the gear and a module M (mm) of the gear satisfies an expression of DI≦0.12×M+0.2.

According to the producing method of a gear part of the present invention, a shallow quench hardened layer can be formed around the teeth surface of the gear part by controlling the DI value.

Next, the function of each of the alloy elements used in the present invention will be explained.

(Carbon of 0.43 to 1.2 wt %)

Carbon is an element to improve a hardness of martensite formed by induction hardening significantly. In order to increase the hardness of martensite to HRC55 or more, it is necessary that carbon of an amount of 0.3 wt % or more is added to the martensite. By the way, almost all carbon contained in a pretreated steel is precipitated as cementite. In the present invention, an alloy element such as Mn, Cr, Mo, V and Mo which improves a hardenability concentrates in cementite, thereby causing concentration of the alloy element in ferrite phase to decrease on the contrary. From the point, as an amount of the cementite increases (in other words, as an amount of added carbon increases), the following advantages can be obtained:

(1) a deep tempered martensite structure of 550° C. or more can be formed around the surface of the steel by increasing the amount of the alloy element added in the steel, and,
(2) an induction hardenability can be suppressed by increasing concentration of the alloy element in the ferrite during tempering.

From the results, the lower limit of the addition amount of carbon is set to 0.43 wt %, and the upper limit thereof is set to 1.2 wt % in view of machinability of the gear. And, the concentration of carbon in the martensite is preferably set to 0.3 to 0.7 wt % in view of quenching crack.

Next, it will be studied that a carbon steel containing carbon of 0.8 to 1.2 wt % for a pretreated steel is heated at a two-phases region, which is formed by austenite and cementite, from Ac1 transformation temperature to 900° C. to disperse cementite particles of 5% by volume or less and then cooled. For example, in a steel to which Cr of 0.6 wt % and carbon of 1.2 wt % are added, Cr of 4.5 wt % concentrates in the cementite phase. And, grain cementite dispersed and precipitated at the two-phases region, having an average diameter of 0.1 to 1.5 μm, does not dissolve by later induction hardening. However, in the present invention, such dispersion of cementite is allowable.

### (Si)

Si is an element to increase tempering resistance at a low temperature tempering in the range of 350° C. or less. The mechanism to increase the tempering_resistance is such that ∈ carbide precipitated at a low temperature is more stabilized and a temperature at which cementite is precipitated is brought to higher in order to prevent softening.

The lower limit of the addition amount of Si is set to about 0.5 wt % in order to achieve tempering resistance equal to or more that of a carburized gear, based on softening resistance ΔHRC of Si per 1 wt % being 4.3 when tempered at 300° C. On the other hand, the upper limit thereof may be set to 3 wt % in such a way that Ac3 transformation temperature does not exceed 900° C. in a range of coexistent carbon amount of 0.35 to 0.9 wt % in order to prevent the quenching temperature from becoming too high. Note that the upper limit of addition amount of Si is preferably set as low as an amount of 2 wt % in order to prevent Si concentrated in the ferrite phase in a pretreated steel from enhancing a induction hardenability too much. In addition, the addition amount of Al is about 0.25 wt % when Si of 0.15 wt % coexists with Al. So, it is possible that the lower limit of an addition amount of each of Al and Si is about 0.25 wt % and 0.15 wt %, respectively. Or, it is also possible that the lower limit of an amount of mixture of Al and Si is set to 0.4 wt %.

### (Al)

Al shows an intensive deoxidation action and works so as to exclude an impurity element such as P and S containing in a steel from the crystal grain boundary. Therefore, it is effective to clean a steel. In addition, Al can significantly improve toughness by coexistence with Ni, as described later. And, the present invention reveals that Al has higher tempering resistance than that of Si (for example, Al has ΔHRC of 7.3). In the present invention, the addition amount of Al is set to 0.25 to 1.25 wt % when only Al is added, while the addition amount of Al and Si is set to 0.5 to 2 wt % when Si is partially substituted with Al of 0.15 to 1.25 wt %. As described above, since Al has a ferrite stabilized ability than Si and makes Ac3 transformation temperature about 1.6 times as high as Si, the upper limit of the addition amount of Al is set to 1.25 wt % or less (that is, 2 wt %/1.6), and is preferably maintained as low as 1 wt % in order to prevent the quenching temperature from becoming too high.

### (Mn)

Mn concentrates in cementite in a pretreated steel, but not so much as Cr, and remains in ferrite, which coexists with the cementite, more than a necessary amount, resulting in significantly increasing a hardenability. Accordingly, in the present invention, the addition amount of Mn is maintained as low as 0.05 to 0.55 wt %, while Si and Al which increase tempering resistance should be added. Therefore, it is preferable that the upper limit of the addition amount of Mn is set to 0.45 wt %. In addition, since Mn has a desulflization ability, it is preferable that a containing amount of S is decreased in response to the addition amount of Mn. And, it is also preferable that a desulflization element such as Ti, Zr and Ca is added.

### (Cr)

Cr is an element concentrated in cementite significantly during heating under a condition in which austenite coexists with cementite at the spheroidization treatment, or during heating under a condition in which ferrite coexists with cementite at A1 transformation temperature or less. When cementite in which Cr of an amount of about 3.5 wt % or more concentrates is contained in a pretreated steel, Cr causes a large amount of cementite to remain in the quench hardened layer formed by induction hardening. Accordingly, in the present invention, the addition amount of Cr should be set such that an average concentration of Cr in the cementite does not exceed 3.5 wt %. For example, when carbon steels containing carbon of 0.9 wt % and 0.45 wt % are heated at 700° C. sufficiently, each upper limit of the addition amount of Cr is 0.6 wt % and 0.4 wt %, respectively. And, when the concentration of Cr in cementite becomes 3.5 wt %, the concentration of Cr in ferrite is 0.13 wt % determined by using the distribution coefficient αKCr of Cr. Accordingly, it is preferable that an amount of Cr in ferrite phase is set to 0.13 wt % or less in order to suppress a hardenability sufficiently.

As described above, in the present invention, the addition amount of Mn is maintained as low as possible, while Si and Al enhancing tempering resistance should be added. However, in order to prevent graphitization of cementite due to addition of Si, it is preferable to add one or more element of Cr, V and Mo of an amount of 0.05 wt % or more.

### (Ni)

Ni is an element concentrated in ferrite in a pretreated steel significantly to enhance an induction hardenability. Addition of Ni of an amount of 0.3 to 2.5 wt % with respect to the aforesaid addition amount of Al can exhibit high toughness. Especially, it is known that each high hard martensite structures containing carbon of 0.6 and 1.2 wt % has an excellent Charpy impact ability and improves impact resistance of a gear remarkably. So, it is preferable that a material having the high hard martensite structure is used for a gear. In the present invention, the upper limit of the addition amount of Ni is set to 1.5 wt % in view of a hardenability and efficiency by the addition of Ni.

### (Mo)

Mo is an element concentrated in the cementite phase in a pretreated steel, but not so much as Cr, and remains in ferrite, which coexists with the cementite, more than a necessary amount, resulting in significantly enhancing a hardenability. Accordingly, although the present invention does not require Mo, since Mo is an element to suppress temper brittleness occurred due to the existence of P and S, it is preferable that Mo of an amount of 0.05 to 0.3 wt % is added. The aforesaid is applied to W as well.

As explained above, in the present invention, a gear part having a quench hardened layer around the teeth surface of the gear part formed by an induction hardening (induction heating) and producing method of the same can be provided. More particularly, an induction hardened gear excellent in pitting strength in which preventing the quench hardened layer from through-hardening allows compressive residual stress to remain at the pitch circle of the gear part and producing method of the same is provided.

Referring to the attachment drawings, there will be explained a gear part and a method of producing thereof according to preferred embodiments of, the present.

### Example 1

### (Pitting Strength of Quenched and Tempered Carbon Steels and Carburized Case Hardened Steels (Pre-Test))

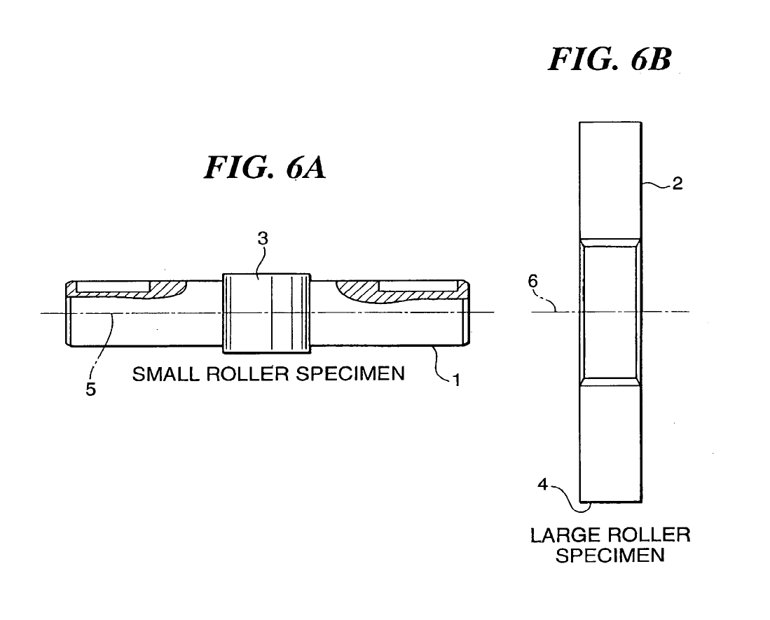

In this example, a roller pitting test was carried out in order to observe rolling fatigue strength of a gear when rotating with sliding. In this roller pitting test, pitting strength of various kinds of quenched and tempered steels and carburized case hardened steels was observed by using each specimen shown in FIGS. 6(a) and (b), which were made of the quenched and tempered steels and the carburized case hardened steels. Table 1 shows a chemical composition of each of the various kinds of the quenched and tempered steels and the carburized case hardened steels, prepared for this example. Each steel was first formed into a small roller specimen shown in FIG. 6(a). And, the small roller specimens Nos. 1, 2, and 4 were heated for 30 minutes at 820° C., and after water quenching, further tempered for 3 hours at 160° C. to be prepared for this test. On the other hand, the small roller specimens Nos. 3 and 4, after thermal refining, were heated at the rolling surface thereof at 950° C. by using a high-frequency power supply (40 kHz, 200 kW) to quench harden, and tempered. Then, the small roller specimens Nos. 3 and 4 were further tempered for 3 hours at 160° C. to be prepared for the test as well. And, the small roller specimen No. 5 was carburized (carbon potential 0.8) at 930° C. for 5 hours and cooled down up to 850° C. After being maintained at 850° C. for 30 minutes, the small roller specimen No. 5 was quenched by quenching oil of 60° C. and further tempered for 3 hours at 160° C. to be prepared for the test.

TABLE 1

| | C | Si | Mn | Ni | Cr | Mo | REMARKS |
|---|---|---|---|---|---|---|---|
| No. 1 | 0.55 | 0.23 | 0.71 | | | | S55C |
| No. 2 | 0.77 | 0.21 | 0.74 | | | | EUTECTOID CARBON |
| | | | | | | | STEEL (1) |
| No. 3 | 0.85 | 0.22 | 0.81 | | 0.43 | | EUTECTOID CARBON |
| | | | | | | | STEEL (2) |
| No. 4 | 0.98 | 0.27 | 0.48 | | 1.47 | | SUJ2 |
| No. 5 | 0.19 | 0.22 | 0.75 | | 0.97 | 0.15 | SCM420H |

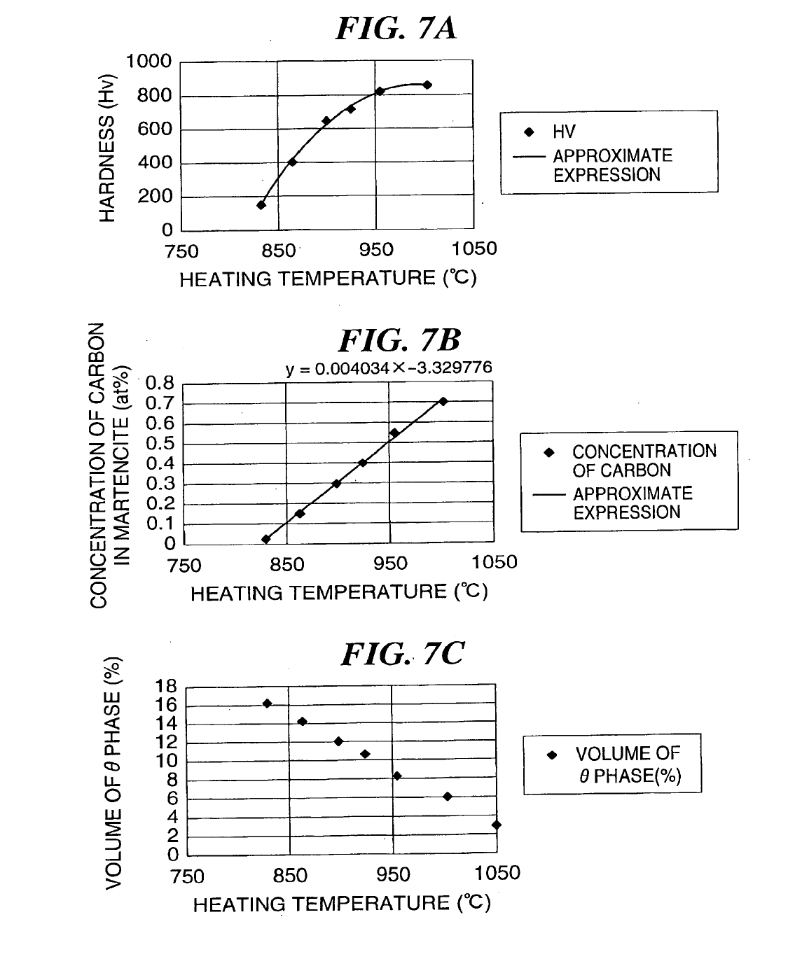

The specimen No. 4 made of spheroidized SUJ2 was induction heated in a temperature range of 800° C. or more, relatively slowly, at a rate of 5° C./sec, and after being maintained at a predetermined temperature for about 5 seconds, was water quenched. Then, hardness of the formed quench hardened layer was measured. By using the measured hardness of the formed quench hardened layer, a relationship between a concentration of carbon in martensite of the quench hardened layer and an amount of undissolved cementite thereof was evaluated and shown in FIG. 7(a), (b) and (C). From the relationship, it is apparent that concentrating of Cr in cementite caused a delay in dissolution of cementite to austenite. Therefore, in order to obtain martensite having sufficient hardness, a heating treatment of at least 925° C. or more was required. It is known that even if the heating temperature was raised to 1000° C., cementite of 6% or more by volume still remained without dissolution. When the specimens Nos. 3 and 4 were quenched at an induction hardening temperature of 950 to 980° C. and then tempered at 160° C. for 3 hours, cementite of 2% by volume remained for specimen No. 3, and cementite of 10% by volume remained for specimen No. 4.

Also, a large roller was prepared such that SUJ2 having a chemical composition of No. 4 of Table 1 was heated at 820° C. for 30 minutes, and after water quenched, tempered at 160° C. for 3 hours. The roller pitting test was carried out by using a test machine having two parallel rotating axes. A small roller specimen 1 and the large roller 2 were arranged so that each center axis and 6 thereof was aligned with each of the rotating axis, in contact a test surface 3 of the small roller 1 with a test surfaces 4 of the large roller. 2 at a predetermined pressure. And, each rotating axis was rotated at a suitable revolution speed, respectively, such that the test surfaces 3 and 4 are proceeded in the same direction. This test was carried out while applying lubrication with engine oil #30 of 70° C. under such condition that a revolution speed of the small roller specimen is 1050 rpm and a revolution speed of the large roller (load roller) is 292 rpm with a slip rate of 40% and contact stress varying within the range of 375 to 220 kgf/mm².

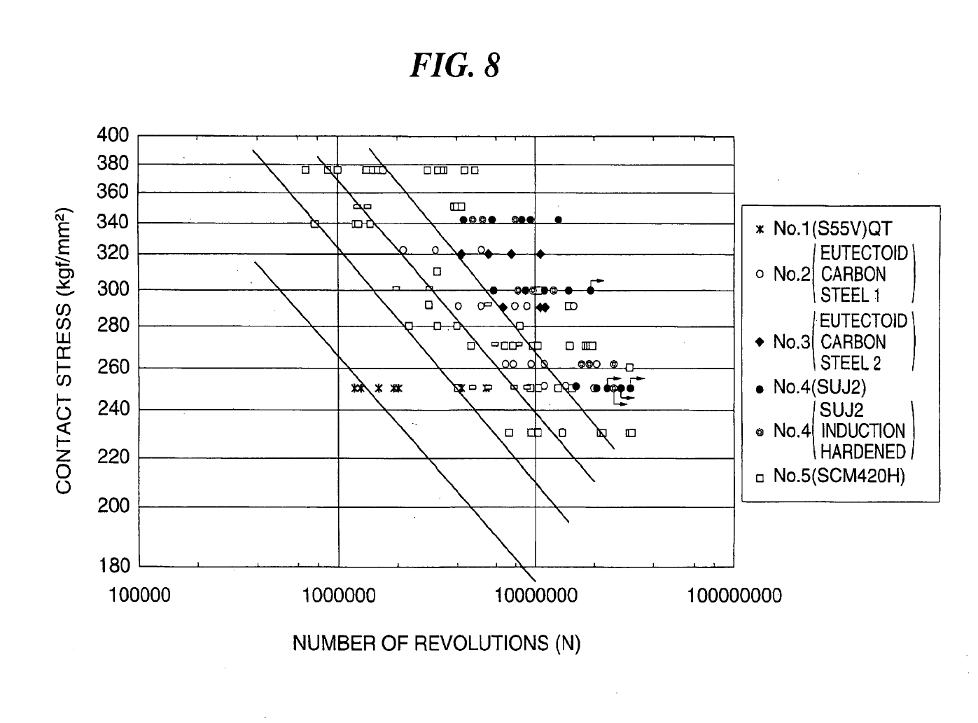

FIG. 8 shows the number of revolutions of the small roller specimen until one pitting occurs in the small roller specimen under various contact stresses. Here, one revolution of a small roller specimen is defined as one time. In the FIG. 8, the abscissa axis shows the number of revolutions until one pitting occurs and the ordinate axis shows a contact stress at which pitting occurs first. In the figure, a life duration line, which is formed by connecting the minimum number of revolutions in which one pitting occurs in a reference carburized case hardened steel (No. 5) at each contact stress, is represented by solid line therein. In a case where contact stress at which the number of revolutions until one pitting occurs first is 10⁷ times is defined as rolling surface fatigue strength (pitting strength), it was found that the pitting strength was about 210 kgf/mm². In the same applied as the case above, pitting strengths of No. 1, No. 2, No. 3 (induction quenching), No. 4, No. 4 (induction quenching) small roller specimens were 175 kg f/mm², 240 kgf/mm², 260 kgf/mm², 270 kf/mm² and 290 kgf/mm², respectively. From the results, it is found that rolling surface fatigue strength of each Nos. 3 and 4, to which cementite particles of about 2% by volume and about 10% by volume, respectively, were dispersed, were significantly improved. And, the carburized case hardened steel varied in rolling surface fatigue strength widely. This is because of a grain boundary oxidization at the rolling surface by carburization, an insufficiently quenched layer and also a large amount of retained austenite. When compared using an average number of revolutions until one pitting occurs first, pitting strength each of Nos. 3 and 4 was not different from that of No. 2.

And, a half bandwidth of X-ray of the martensite phase of a rolling surface at which pitting occurred first was measured. As the result, the bandwidth of No. 1, No. 2, No. 3, No. 4 and No. 5 were 3.6 to 4.0°, 4 to 4.2°, 4.2 to 4.4°, 4.3 to 4.6° and 4 to 4.2°, respectively.

When the aforesaid heat treated specimens Nos. 1 to 5 were tempered at 250 to 350° C. for 3 hours, the half bandwidth of X-ray of each specimen was examined. As a result, the measured half bandwidth of X-ray of rolling surface at which pitting occurred well agreed with that of each of the specimens Nos. 1 to 5 tempered at 300° C. And, the measured half bandwidth well satisfied with the relationship between tempering hardness and half bandwidth of carbon steels having various carbon concentrations, which is described in Material, Volume 26, No. 280, p 26.

### Example 2

### (Tempering Resistance)

Table 2 shows each composition of alloy elements used in the example. The specimens were heated at 810 to 870° C. for 30 minutes, and after being cooled, tempered at 300° C. and 350° C. for 3 hours. And, Rockwell Hardness (HRC) of each of specimens was examined, and effects of the addition amount of various alloy elements on the hardness were analyzed.

TABLE 2

| TPNo. | C | Si | Al | Mn | Ni | Cr | Mo | V | B |
|---|---|---|---|---|---|---|---|---|---|
| No. 6 | 0.45 | 1.45 | | 0.46 | | 1.49 | 0.52 | 0.14 | 0.0018 |
| No. 7 | 0.49 | 1.45 | | 0.46 | | 1.01 | 1.03 | 0.15 | 0.0019 |
| No. 8 | 0.47 | 0.31 | | 0.46 | | 2.01 | 1.03 | 0.15 | 0.0019 |
| No. 9 | 0.49 | 0.29 | | 0.45 | | 1.5 | 1.49 | 0.23 | 0.0019 |
| No. 10 | 0.36 | 1.77 | | 0.6 | | 0.62 | 0.11 | | 0.0026 |
| No. 11 | 0.45 | 0.95 | | 0.66 | 0.01 | 1.29 | 0.5 | | 0.0029 |
| No. 12 | 0.39 | 0.93 | | 1.02 | 0.08 | 0.97 | 0.95 | 0.5 | |
| No. 13 | 0.43 | 0.26 | | 0.44 | | 1.01 | 0.48 | | 0.001 |
| No. 14 | 0.47 | 0.25 | | 0.4 | | 1.01 | 1.05 | | 0.0018 |
| No. 15 | 0.46 | 1.5 | | 0.4 | | 1 | 0.51 | | 0.002 |
| No. 16 | 0.45 | 0.24 | | 0.4 | | 1.02 | 0.48 | 0.31 | 0.0011 |
| No. 17 | 0.45 | 1.46 | | 0.39 | | 0.96 | 0.98 | | 0.001 |
| No. 18 | 0.41 | 0.25 | | 0.35 | | 1 | 0.49 | | 0.0017 |
| No. 19 | 0.52 | 2.3 | | 0.57 | | 0.11 | | | |
| No. 20 | 0.98 | 0.27 | | 0.48 | | 1.47 | | | |
| No. 21 | 0.55 | 0.23 | | 0.71 | | | | | |
| No. 22 | 0.77 | 0.21 | | 0.74 | | | | | |
| No. 23 | 0.45 | 0.21 | 1.26 | 0.53 | | 1.51 | 0.21 | | |
| No. 24 | 0.6 | 0.25 | 0.97 | 0.93 | 0.98 | 1.04 | 0.35 | | |

On the other hand, a carbon steel containing carbon of 0.1 to 1.0 wt % and Mn of 0.3 to 0.9 wt % was pre-tested for measurement of the hardness. The hardness obtained by the pre-test was used for analysis of the effect of the alloy element on the hardness. From the result, each of hardness of carbon steel at a tempering temperature of 250° C., 300° C. and 350° C. was approximated to expressions:

HRC=34× square of carbon concentration (w %)+26.5 (at 250° C.);

HRC=36× square of carbon concentration (wt %)+20.9 (at 300° C.); and

HRC=38× square of carbon concentration (wt %)+15.3 (at 350° C.)

Then, by using the hardness of the carbon steel, the effect of each alloy element was analyzed. As a result, tempering resistance ΔHRC at 300° C., for example, was demonstrated by an expression of ΔHRC=4.3×Si (wt %)+7.3×Al (wt %)+1.2×Cr (wt %)×(0.45/C(wt %))+1.5×Mo (wt %)+3.1×V (wt %).

From the expression, it is found that Al has tempering resistance of 1.7 times more than Si, whereby Al is an effective element to improve rolling contact strength.

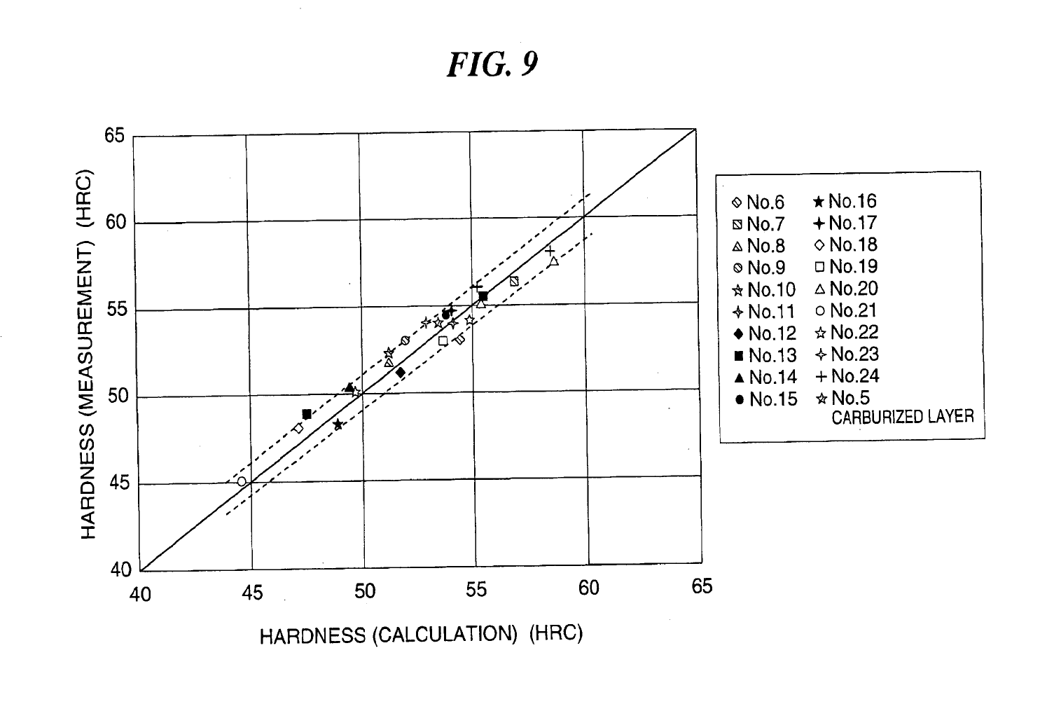

FIG. 9 shows an agreement between tempering hardness obtained from the result of the analysis and tempering hardness obtained by measurement. As shown in the figure, HRC can be accurately expected within a margin of ±1. Moreover, in FIG. 9, a measured tempering hardness at 300° C. of a carburized layer (carbon of 0.8 wt %) of SCM420 (No. 5) in Example 1 was shown with a mark ⋆. The result shows that a measured hardness well agreed with an expected hardness.

### Example 3

### (Adjustment of Induction Hardenability)

Table 3 shows the composition of each alloy element which was contained in steels used in this Example 3. Each steel was machined into columned-shape pieces, having 30 mm in diameter and 10 mm in length. One group of the pieces was heated at 850 to 900° C. for one hour and then water-cooled. And, another group of the pieces was also heated at 850 to 900° C. for one hour, and, after water cooled, tempered at 650° C. for 5 hours. Then, all the pieces of both group was evenly heated at 870° C. for 15 seconds by using a 3 kHz induction heating device and then water cooled. Finally, the depth of the quench hardened layer of each piece was measured.

TABLE 3

| | | | | | | | | | | DI | GEAR | CONCENTRATION |
|---|---|---|---|---|---|---|---|---|---|---|---|---|
| | | | | | | | | | | VALUE | MODULE | (wt %) |
| | C | Si | Mn | Ni | Cr | Mo | P | S | Al | (in) | M | OF Cr in θ PHASE |
| No. P1 | 0.58 | 0.21 | 0.28 | | 0.16 | 0 | | | 0.024 | 0.74 | 4.5 | |
| | 0.58 | 0.23 | 0.14 | 0.00 | 0.04 | 0.00 | 0.00 | 0.00 | 0.03 | 0.46 | 2.1 | 1.4 |
| No. P2 | 0.58 | 0.11 | 0.28 | | 0.55 | 0.12 | | | 0.024 | 1.53 | 11.1 | |
| | 0.49 | 0.12 | 0.14 | 0.00 | 0.13 | 0.07 | 0.00 | 0.00 | 0.03 | 0.56 | 3.0 | 4.9 |
| No. P3 | 0.55 | 0.61 | 0.2 | | 0.19 | 0 | | | 0.018 | 0.80 | 5.0 | |
| | 0.55 | 0.66 | 0.10 | 0.00 | 0.05 | 0.00 | 0.00 | 0.00 | 0.02 | 0.52 | 2.6 | 1.8 |
| No. P4 | 0.7 | 1.18 | 0.22 | | 0.31 | | | | 0.019 | 1.43 | 10.2 | |
| | 0.55 | 1.32 | 0.10 | 0.00 | 0.069 | 0.00 | 0.00 | 0.00 | 0.02 | 0.70 | 4.1 | 2.4 |
| No. P5 | 0.61 | 0.09 | 0.26 | 0.51 | 0.31 | | | | 0.51 | 1.78 | 13.2 | |
| | 0.51 | 0.10 | 0.12 | 0.54 | 0.07 | 0.00 | 0.00 | 0.00 | 0.56 | 0.93 | 6.1 | 2.7 |
| No. P6 | 0.91 | 0.8 | 0.51 | 0.03 | 0.35 | | | | 0.019 | 2.28 | 17.3 | |
| | 0.65 | 0.92 | 0.19 | 0.03 | 0.06 | 0.00 | 0.00 | 0.00 | 0.02 | 0.81 | 5.1 | 2.2 |
| S55C + IQT | 0.54 | 0.22 | 0.81 | | 0.12 | | | | 0.015 | 1.25 | 8.7 | |
| | 0.54 | 0.24 | 0.41 | 0.00 | 0.03 | 0.00 | 0.00 | 0.00 | 0.02 | 0.69 | 4.1 | 1.1 |

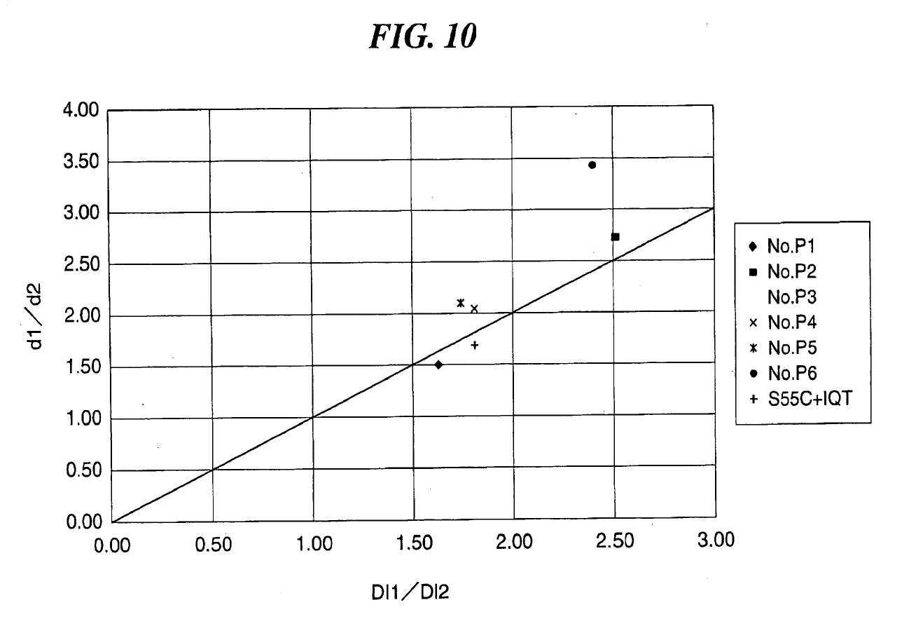

FIG. 10 shows a relationship between a ratio (DI1/DI2) of the DI value 1 (DI1), obtained chemical composition shown in Table 3, to the DI value 2 (DI2), calculated by chemical composition of ferrite which is calculated by the tempering treatment at 650° C., and a ratio (d1/d2) of the depth (d1) of quench hardened layer of pieces which are not tempered at 650° C., to the depth (d2) of quench hardened layer of pieces which are tempered at 650° C. From FIG. 10, it is found that the tempering treatment at 650° C., carried out before an induction hardening treatment, caused remarkably reduce a hardenability. And, it is also found that a hardenability was well controlled. In FIG. 10, referring to piece No. 6, it does not agree with a straight line of FIG. 10. This is because cementite of about 3.5% by volume in the pretreated steel remained as undissolved state and a concentration of carbon in martensite lowered so that the DI value 2 decreased. In Table 3, each concentration of carbon in quenched martensite is displayed under each specimen. By using the DI value 2 and the expression of DI=0.12×M+0.2, the present invention is apparently best suited to a method for producing a small and medium sized induction hardening gear part having high resistance of contact stress and a deep quench hardened layer around the teeth surface of the gear part.

### Example 4

### (Improvement Pitting Strength by Employing Steels Having High Tempering Resistance)

In this example, specimens having the same shape as those of the specimens used in Example 1 were prepared by parting off from the steels used in Example 3, of which were tempered at 650° C. for 3 hours. By using the same induction heating device as in Example 1, the specimens were first slowly heated up to 400° C. for 10 seconds, and next rapidly heated up to 1050° C. for one second, and then water cooled. After being water cooled, the specimens were further tempered at 160° C. for 3 hours so as to be prepared for a roller pitting test.

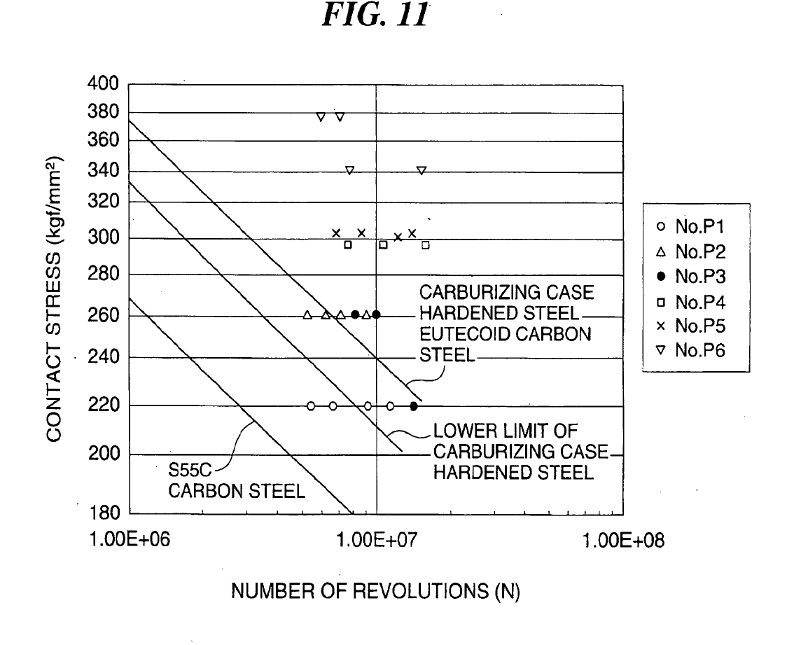

In No.P4, No.P5 and No.P6 in Table 3, a little amount of undissolved cementite was dispersed in a rolling surface layer thereof. The dispersed amount of cementite was 3% by volume or less. Pitting strength was tested under substantially the same condition as in Example 1. The test results are shown in FIG. 11, in which the pitting occurrence line (results in FIG. 9), obtained in Example 1, is represented by a solid line.

From the results obtained by the above examples, addition of Al and Si caused improvement in tempering resistance, thereby significantly enhancing pitting strength of a rolling surface.

### Example 5

### (Improvement in Slipping Resistance by Dispersion of Carbide, Nitride and Carbonitride)

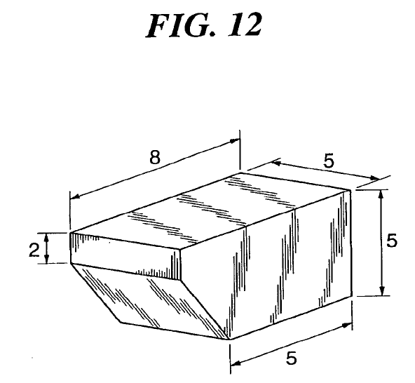

This Example employed the same steels used in Example 3, as shown in Table 4, and steels containing V and Ti. And, specimens, as shown in FIG. 12, were made of the aforesaid steels for measurement of slipping resistance. On the other hand, a relative specimen was prepared such that SCM 420 was carburized and tempered so as to make the surface hardness of HRC60. Then, the specimen was forced against a disk-shaped upper surface of the relative specimen to the lower surface thereof to stabilize each specimen with respect to a level surface. And, then the relative specimen is rotated at a revolution speed of 10 m/sec with applying lubrication by using engine oil #30 of 80° C. Then, a constant force pressure is maintained for 5 minutes and then the force pressure increases every 25 kgf/cm². And, a fore pressure (kgf/cm²) at which a friction coefficient suddenly increases (seizure state) was measured.

TABLE 4

| | | | | | | | | | | AMOUNT OF | CONTACT |
|---|---|---|---|---|---|---|---|---|---|---|---|
| | | | | | | | | | | CEMENTITE | STRESS AT |
| | | | | | | | | | | (% BY | SEIZURE |
| | C | Si | Mn | Ni | Cr | Mo | Al | V | Ti | VOLUME) | (kgf/cm²) |
| No. P1 | 0.58 | 0.21 | 0.28 | | 0.16 | 0 | 0.024 | | | 0 | 300 |
| No. P2 | 0.58 | 0.11 | 0.28 | | 0.55 | 0.12 | 0.024 | | | 1 | 350 |
| No. P3 | 0.53 | 0.61 | 0.2 | | 0.19 | 0 | 0.018 | | | 0 | 300 |
| No. P4 | 0.7 | 1.18 | 0.22 | | 0.31 | | 0.019 | | | 0.5 | 325 |
| No. P5 | 0.61 | 0.09 | 0.26 | 0.51 | 0.31 | | 0.51 | | | 1 | 325 |
| No. P6 | 0.91 | 0.8 | 0.51 | 0.03 | 0.35 | | 0.019 | | | 3 | 400 |
| No. S1 | 0.63 | 0.58 | 0.38 | | | | 0.021 | 0.46 | | 1 | 325 |
| No. S2 | 0.73 | 0.71 | 0.46 | | 0.49 | | | | 0.19 | 2 | 425 |
| S55C + QT | | | | | | | | | | | 275 |
| SCM420 + GCQT | | | | | | | | | | | 300 |
| SCM440 + QT | | | | | | | | | | | 275 |
| SUJ2 + QT | | | | | | | | | | | 400 |

Specimens used for the slipping test were induction hardened and tempered in the same way as in Example 3. As relative specimens, a carburized and tempered SCM420 (SCM420+GCQT), and quenched and tempered SCM440(SCM440+QT), S55C(S55C+QT) and SUJ(SUJ2+Q) were used.

Table 4 shows the result of this Example. From Table 4, it is found that regarding No.S1, No.S2 and No.S6, dispersion of carbide hard grains improved seizure resistance. Specifically, addition of Ti improved seizure resistance significantly.

Therefore, dispersion of a slight amount of Nb, Zr and Hf like Ti and V is preferred so as to enhance wear resistance and contact strength of a gear part which used with slipping.

The present invention is not limited to the above-mentioned embodiments, and within the scope of the subject matter of the present invention, various modifications may be allowable.

What is claimed is:

1. A producing method of a gear part comprising the steps of:
preparing a original gear part made of steel containing carbon of an amount of 0.43 to 1.2 wt %, in which the relationship between a DI value (inch) showing a hardenability of austenite phase at a pitch circle of the gear part and a module M (mm) of the gear part satisfies an expression of DI≦0.12×m+0.2, and
forming a quench hardened layer around the teeth surface of the gear part by induction hardening.

2. The producing method of a gear part according to claim 1, wherein an alloy element concentrates in cementite phase in a pretreated steel, thereby causing concentration of the alloy element in ferrite phase in the pretreated steel to decrease, and a rapid induction heating to A3 transformation temperature or Acm transformation temperature or more causes an amount of 0.3 to 0.8 wt % carbon to diffuse and dissolve in austenite phase, and a DI value is determined by using a concentration of the alloy element in the ferrite phase and a concentration of the carbon which diffuses and dissolves in the austenite phase.

3. The producing method for the gear part according to claim 1, wherein the induction hardening is carried out by heating the original gear part from A1 transformation temperature or less up to a quenching temperature of 900 to 1100° C. by a high frequency within 10 seconds for austenitizing and then rapidly cooling.

4. The producing method of a gear part according to claim 1, wherein the induction hardening is carried out by first pre-heating the original gear part at 300° C. to A1 transformation temperature, second induction heating within 3 seconds by high power, and then rapid cooling.

5. The producing method for the gear part according to claim 1, wherein, after the step for forming a quench hardened layer, a step for maintaining compressive residual stress of 50 kgf/mm² or more to the teeth surface layer including teeth tips, teeth addendums, teeth surface at the pitch circle, dedendums and the teeth roots of the gear part by physically processing the gear part is added.

6. The producing method of a gear part according to claim 5, wherein the physically processing is a shot peening process.

7. The producing method of a gear part according to claim 6, wherein the shot peening process causes compressive residual strength of 50 kgf/mm² or more to remain at the edge of the teeth surface.
